(19) United States
(12) Patent Application Publication
(10) Pub. No.: US 2026/0267072 A1
(43) Pub. Date: Sep. 10, 2026

(54) FIBER TO CHIP INTERCONNECTS

(71) Applicant: Molex, LLC, Lisle, IL (US)

(72) Inventors: Thomas Randall Marrapode, Naperville, IL (US); Russell Kevin Stiles, Kingston, TN (US)

(21) Appl. No.: 19/539,074

(22) Filed: Feb. 13, 2026

Related U.S. Application Data
(60) Provisional application No. 63/766,393, filed on Mar. 4, 2025.

(51) Int. Cl. G02B 6/30

(52) U.S. Cl. CPC G02B 6/30

(57) ABSTRACT

Optical interconnect assemblies, optical cable assemblies, and methods of assembly thereof are described. An example optical cable assembly includes a fiber optic cable and a coupling block positioned at one end of the cable. The coupling block includes upper and lower block surfaces, a window aperture that extends through the coupling block, a board recess formed in the lower block surface, a cable termination bay adjacent to the lower block surface, and cable passages that extend from the cable termination bay to the board recess. Optical fibers of the fiber optic cable extend along the cable channels and across or over the window aperture of the coupling block. The optical fibers can be accurately trimmed in length using one or more fiducial markers on the coupling block, and thermally expanded core processing techniques can be applied to the optical fibers or the ends of the optical fibers.

### BACKGROUND

The amount of data processed by computing, network switching, telecommunications, and related systems continues to increase. Data centers can include hundreds or thousands of networking and computing systems. The systems are interconnected by optical cables, copper cables, and various connectors, adapters, and terminations between them. The data throughput of the interconnection systems is high and increasing. A range of different input/output (I/O) connectors, cables, cable assemblies, and interconnect systems are designed for those types of data, power, and data and power interconnection applications.

Example interconnect systems include board-to-board, cable-to-cable, wire-to-wire, and cable- or wire-to-board systems. A variety of designs exist for each type of connector, cable assembly, and interconnect system, depending on the requirements of the power and data communications environment in which the connectors, assemblies, and systems are used. As one example, a cable-to-cable optical connector assembly includes a first optical connector assembly attached to the free end of a first fiber optic cable. A second optical connector assembly is attached to the free end of a second fiber optical cable, and the first and second optical connector assemblies can be connected or mated to each other. As another example, a cable-to-board optical connector assembly includes an optical cable assembly terminated to a circuit board or substrate.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

Aspects of optical interconnect assemblies, optical cable assemblies, and methods of assembly thereof are described. An example optical cable assembly includes a fiber optic cable and a coupling block positioned at one end of the cable. The coupling block includes upper and lower block surfaces, a window aperture that extends through the coupling block, a board recess formed in the lower block surface, a cable termination bay adjacent to the lower block surface, and cable passages that extend from the cable termination bay to the board recess. Optical fibers of the fiber optic cable extend along the cable channels and across or over the window aperture of the coupling block. The optical fibers can be accurately trimmed in length using one or more fiducial markers on the coupling block, and thermally expanded core processing techniques can be applied to the optical fibers or the ends of the optical fibers.

In other aspects, the coupling block can also include a cable termination bay adjacent to the lower block surface. The cable termination bay can include a recess region, and a jacket of the ribbon fiber optic cable can be secured to the coupling block in the recess region. In another example, the cable termination bay can include a recess slot, and a jacket of the ribbon fiber optic cable can be secured to the coupling block in the recess slot.

In other aspects, each optical fiber of the ribbon fiber optic cable can be positioned in a respective cable passage among the plurality of cable passages. Each optical fiber of the ribbon fiber optic cable can extend a length past the positioning edge and into the window aperture. The plurality of cable passages can include a plurality of cable channels formed in a wave shape. In another example, the plurality of cable passages can include a plurality of cable channels formed in a “V” shape. In another example, the plurality of cable passages can include a plurality of apertures that extend through the coupling block. A surface of the plurality of cable passages intersects with a plane in which a board recess surface of the board recess extends in some embodiments.

An example coupling block for an optical cable includes an upper block surface and a lower block surface, a window aperture that extends through the coupling block from the upper block surface to the lower block surface, a board recess formed in the lower block surface, and a plurality of cable passages. The board recess can include a positioning edge extending along one side of the board recess.

In other aspects, the plurality of cable passages can be formed in the lower block surface, and the plurality of cable passages can extend to a positioning edge of the coupling block along one side of the board recess. The coupling block can also include a cable termination bay adjacent to the lower block surface. The cable termination bay can include a recess region in some cases. In other cases, the cable termination bay can be formed as a recess slot.

The plurality of cable passages can include a plurality of cable channels formed in a wave shape. In another example, the plurality of cable passages can include a plurality of cable channels formed in a “V” shape. In another example, the plurality of cable passages can include a plurality of apertures that extend through the coupling block. A surface of the plurality of cable passages intersects with a plane in which a board recess surface of the board recess extends in some embodiments.

An example optical interconnect assembly includes a substrate and an optical cable assembly secured along an edge of the substrate. The optical cable assembly can include a ribbon fiber optic cable and a coupling block positioned at one end of the ribbon fiber optic cable. The coupling block can include an upper block surface and a lower block surface, a window aperture that extends through the coupling block from the upper block surface to the lower block surface, a board recess formed in the lower block surface, and a plurality of cable passages. The board recess can include a positioning edge extending along one side of the board recess. A plurality of optical fibers of the ribbon fiber optical cable can be positioned in and separated by the plurality of cable passages of the coupling block.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a top perspective view of an optical interconnect assembly according to various embodiments of the present disclosure.

FIG. 1B illustrates a bottom perspective view of the optical interconnect assembly shown in FIG. 1A according to various embodiments of the present disclosure.

FIG. 1C illustrates a bottom perspective view of the optical interconnect assembly shown in FIG. 1A, with parts exploded away from each other, according to various embodiments of the present disclosure.

FIG. 2A illustrates a bottom perspective view of the coupling block in the cable assembly shown in FIG. 1A according to various embodiments of the present disclosure.

FIG. 2B illustrates a bottom perspective view of the cable assembly shown in FIG. 1A according to various embodiments of the present disclosure.

FIG. 3 illustrates the sectional view of the coupling block designated A-A in FIG. 2A according to various embodiments of the present disclosure.

FIG. 4 illustrates another example coupling block according to various embodiments of the present disclosure.

FIG. 5A illustrates a first perspective view of another example coupling block according to various embodiments of the present disclosure.

FIG. 5B illustrates a side view of the coupling block shown in FIG. 5A according to various embodiments of the present disclosure.

FIG. 5C illustrates a second perspective view of the coupling block shown in FIG. 5A according to various embodiments of the present disclosure.

### DETAILED DESCRIPTION

As noted above, the amount of data processed by computers, computing systems, and computing environments continues to increase. Data centers can include hundreds or thousands of networking and computing systems that are interconnected using optical cables, copper cables, and various connectors and terminations therebetween. Some interconnect systems rely upon cable end optical connector assemblies, which can be positioned at the distal ends of one or more optical waveguides (e.g., fiber optic waveguides, fiber optic cables, etc.). The optical waveguides can be bundled together in a ribbon or ribboned format in some cases to facilitate higher data throughputs.

A limited number of solutions are currently available in the field of separable fiber optic connector interfaces for optical connections between optical fibers and photonics integrated circuits (PICs). Current solutions rely upon the precise alignment of connector plugs to PIC receptacles. Features such as pins, V-grooves, and rods are utilized in some solutions, but those solutions are relatively expensive and difficult to implement. The current solutions also fail to take advantage of the precise capabilities of semiconductor fabrication techniques, as those techniques can be relied upon for locating and aligning optical fiber cores to optical elements on PIC substrates. Forming low-loss interfaces can also difficult when attempting to focus optical beams into or out of optical fiber cores with respect to optical elements on PIC substrates. In some cases, one or more optical focusing elements are utilized to match the mode field diameters of PIC elements to the optical fiber cores, which introduces complexities, additional costs, and fabrication difficulties.

In the context outlined above, aspects of optical interconnect assemblies, optical cable assemblies, and methods of assembly thereof are described. An example optical cable assembly includes a fiber optic cable and a coupling block positioned at one end of the cable. The coupling block includes upper and lower block surfaces, a window aperture that extends through the coupling block, a board recess formed in the lower block surface, a cable termination bay adjacent to the lower block surface, and cable passages that extend from the cable termination bay to the board recess. Optical fibers of the fiber optic cable extend along the cable channels and across or over the window aperture of the coupling block. The optical fibers can be accurately trimmed in length using one or more fiducial markers on the coupling block, and thermally expanded core processing techniques can be applied to the optical fibers or the ends of the optical fibers. These and other aspects of the embodiments are described below.

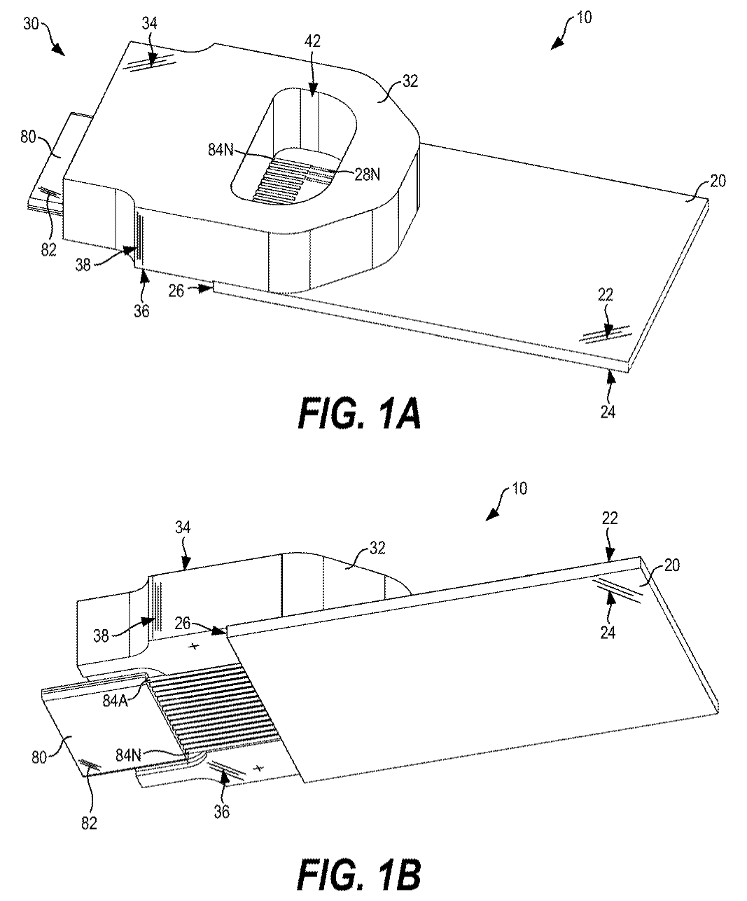

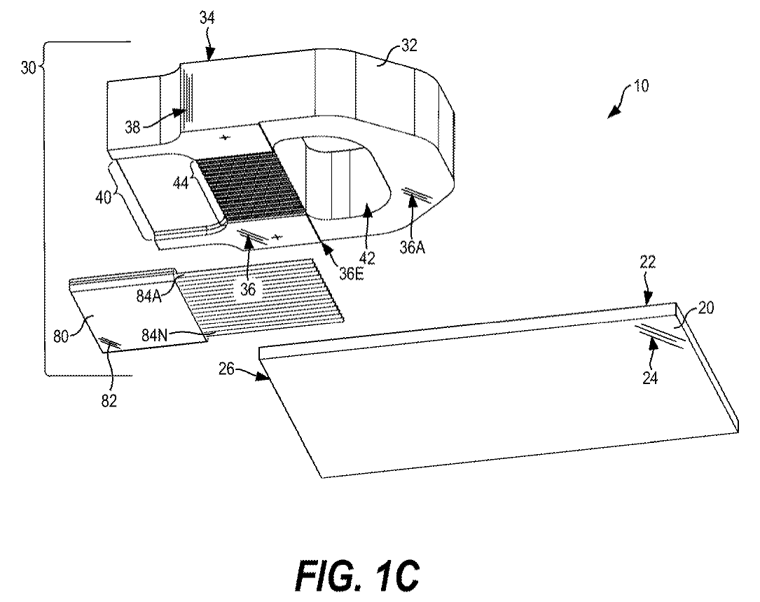

Turning to the drawings, FIG. 1A illustrates a top perspective view of an optical interconnect assembly 10 (also “interconnect assembly 10”) according to various embodiments of the present disclosure. FIG. 1B illustrates a bottom perspective view of the interconnect assembly 10, and FIG. 1C illustrates a bottom perspective view of the interconnect assembly 10 with parts exploded away from each other. The interconnect assembly 10 is illustrated as a representative example in FIGS. 1A-1C. The interconnect assembly 10 is not drawn to any particular size or scale. The orientation, shape, size, style, proportion, and other characteristics of the interconnect assembly 10 can vary as compared to that shown in some cases. One or more features or components of the interconnect assembly 10 can be omitted. In other cases, the interconnect assembly 10 can include other features or components that are not shown or described. Additionally, while the interconnect assembly 10 is described as an optical interconnect assembly, the concepts described herein are not limited to use with optical interconnect applications or systems. The concepts can be extended to a range of different interconnect systems and applications, including electrically conductive and wired systems.

The interconnect assembly 10 includes a substrate 20 and an optical cable assembly 30 (also “cable assembly 30”). The cable assembly 30 is secured along an edge of the substrate 20 in the example depicted. The cable assembly 30 includes a coupling block 32 and a ribbon fiber optic cable 80 (also “cable 80”). The coupling block 32 is secured at a distal end of the cable 80. The cable 80 can be secured to the coupling block 32 in a number of suitable ways described below, such as using epoxy or other adhesives, heat welds, and other approaches. More particularly, an outer jacket 82 of the cable 80 can be secured to the coupling block 32 using an adhesive, as one example among other approaches, as described below. The cable 80 includes optical fibers 84A-84N arranged in a ribbon or flat format within the jacket 82, as shown in FIGS. 1B and 1C. The optical fibers 81A-81N of the cable 80 extend out from the jacket 82, as shown.

The cable assembly 30 is positioned and secured along the edge 26 of the substrate 20 in the example shown in FIGS. 1A and 1B. In that arrangement, the optical fibers 84A-84N of the cable 80 are positioned over a top surface 22 of the substrate 20, and an optical interconnection is established between the optical fibers 84A-84N and optical waveguides on the substrate 20. The coupling block 32 of the cable assembly 30 is also secured to the top surface 22 of the substrate 20, which operates to position and hold the optical fibers 84A-84N in place. The coupling block 32 of the cable assembly 30 can be secured to the top surface 22 of the substrate 20 using adhesives, soldering, sintering, or other approaches.

Additional details of the interconnect assembly 10, and the components thereof, are described below. Among other advantages, the cable assembly 30 offers a cost-effective, robust, and practical solution for interfacing the optical fibers 84A-84N with the substrate 20. More particularly, the cable assembly 30 provides a solution for interfacing the optical fibers 84A-84N with waveguide structures formed in or on the top surface 22 of the substrate 20. The design of the cable assembly 30 can be tailored for a range of different applications and use cases. Example embodiments, materials and components, assembly techniques, design considerations, and other aspects of the cable assembly 30 are described below.

The substrate 20 can be embodied as a range of different types of substrates. The substrate 20 can be embodied as a semiconductor substrate in one example, such as a semiconductor substrate formed from Silicon (Si), Gallium Arsenide (GaAs), Indium Phosphide (InP), Barium-Titanate BaTiO₃, or other semiconductor materials, from optical polymers, and from other materials capable of carrying and transmitting optical energy in the form of light or photons, including combinations thereof. In one example, the substrate 20 can be embodied as a silicon-based integrated circuit (IC) or PIC, with optical waveguides formed in the substrate 20. The size, thickness, and other aspects of the substrate 20 is depicted as an example in FIG. 1A, and the substrate 20 can range in size, shape, and other features. The substrate 20 can be manufactured to include a range of integrated optical components, such as optical mixers, splitters, multiplexers, modulators, laser diodes, and other photonic components, for a range of optical communications and other applications. The substrate 20 can also be formed from other materials in other examples, including polymers, metal, glass, ceramic, and other materials.

FIG. 1A also illustrates optical waveguides of the substrate 20, such as the waveguide 28N, which is aligned and optically coupled to an end of the optical fiber 84N. The distal end of the optical fiber 84N is aligned with the end of the waveguide 28N and secured in place by the cable assembly 30. The waveguide 28N is illustrated and described as a representative example, and other optical components can be formed in or on the substrate 20. The substrate 20 can include optical mixers, splitters, multiplexers, modulators, laser diodes, mode spot converters, focusing elements, and other photonic components, and the optical components can be optically coupled to the optical fibers 84A-84N using the cable assembly 30. The substate 20 can also include channels formed into the top surface of the substate 20 for receiving and positioning the optical fibers 84A-84N into alignment with waveguides or other features on the substrate 20. The channels can be formed at a relatively high level of precision using semiconductor manufacturing process techniques, in at least some embodiments.

The coupling block 32 can be formed from a plastic or polymer, such as liquid crystal polymer (LCP), polyethylene (PE), polytetrafluoroethylene (PTFE), fluoropolymer, or other plastic or insulating material(s). The coupling block 32 is not limited to being formed from polymers, however, and can be formed from other suitable materials, including metal, glass, ceramic, silicon, and other materials. If formed from metal, the coupling block 32 can be formed of Nickel, Copper, Aluminum, Tin, Molybdenum, Zinc, and other metals and metal alloys. The coupling block 32 can be formed using any suitable additive or subtractive manufacturing techniques, including molding, injection molding, printing, embossing, nano imprinting, and other techniques. Preferably, the coupling block 32 can be formed as a single integral piece or part, although the coupling block 32 can also be formed in two or more pieces or parts that fit together in some cases.

The coupling block 32 includes an upper block surface 34, a lower block surface 36, and a side surface 38. The upper block surface 34 and the lower block surface 36 extend in different, parallel planes. The side surface 38 extends around the periphery of the coupling block 32 and includes bends, curves, and angles in the example shown. The coupling block 32 also includes a window aperture 42 that extends through the coupling block 32 from the upper block surface 34 to the lower block surface 36. The coupling block 32 also includes a board recess that is formed into the lower block surface 36 of the coupling block 32. The board recess includes a board recess surface 36A (see FIG. 1C). The lower block surface 36 extends in a plane that is separate from and parallel to the board recess surface 36A. When the cable assembly 30 is interfaced with the substrate 20, the board recess surface 36A of the coupling block 32 rests upon the top surface 22 of the substrate 20. A positioning edge 36E extends along one side of the board recess surface 36A. Along the length of the positioning edge 36E, a portion of the positioning edge 36E is shared and coincides with an inner surface of the window aperture 42. When the cable assembly 30 is interfaced with the substrate 20, the positioning edge 36E abuts up against and contacts the edge 26 of the substrate 20.

One or more outer surfaces of the coupling block 32 can be selectively metalized or plated with a conductive plating metal or metals in some cases, and the coupling block 32 can be embodied as a plated plastic component. In one example, all exterior-facing outer surfaces of the coupling block 32 can be plated with a metal or metals. In other cases, only certain surfaces or surface regions of the coupling block 32 are plated, such as only the board recess surface 36A. The plating can provide an interface for bonding (e.g., soldering, sintering, etc.) the coupling block 32 to the substrate 20, a type of electro-magnetic interference (EMI) shield, and other purposes.

One or more surfaces or surface regions of the coupling block 32 can be etched and metalized or plated in a bath, barrel plated, plated by physical vapor deposition (PVD), plated by electroless plating, electroplating, sputter plating, ion plating, or other plating techniques or a combination thereof. The surfaces of the coupling block 32 can be metalized or plated with Copper, Nickel, Tin, Silver, other plating metals, or combinations of plating metals. In another metallization approach, the material from which the coupling block 32 is formed can include a laser direct structuring (LDS) additive. A laser beam can be used to activate the LDS additive over certain surfaces or surface areas of the coupling block 32 for metallization. A subsequent metallization process can be performed by submerging the coupling block 32 in a bath, and conductive metal plating can adhere to the activated surfaces or surface areas of the coupling block 32. A number of different metal plating layers can be successively plated by that approach.

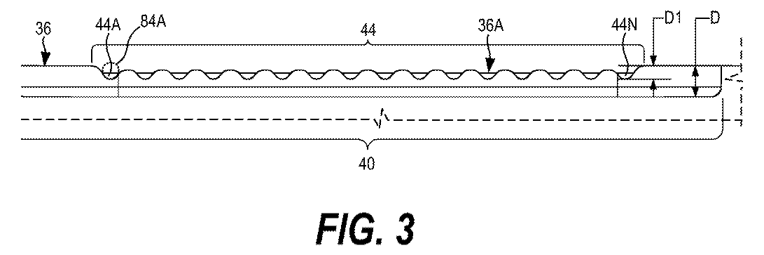

The coupling block 32 also includes a cable termination bay. In the embodiment shown in FIGS. 1A-1C, the cable termination bay is formed as a recess region 40 (see FIG. 1C). The recess region 40 is an area or region of the coupling block 32 that is recessed from the lower block surface 36. The recess region 40 is a depression formed from the lower block surface 36 and into the coupling block 32. The recess region 40 has a type of “U” shape, as shown in the sectional view in FIG. 3 and described below. The recess region 40 provides an area in which the cable 80 can be positioned and secured as described below. Other coupling blocks described herein can include other types of cable termination bays, such as recess regions of different depths, recess regions of different shapes, slots, slits, and other types of cable termination bays for securing the end of a fiber optic cable 80.

In the coupling block 32, a number of cable passages extend from the recess region 40 to the positioning edge 36E of the board recess surface 36A. In the embodiment shown in FIGS. 1A-1C, the cable passages are formed as cable channels 44 (see FIG. 1C). The cable channels 44 can be formed to have curved, wave, semi-circular, “V,” “U,” or other channel profile shapes, as described below, among the embodiments. The depth, spacing, and other characteristics of the cable channels 44 can vary based on design considerations described herein. Other coupling blocks described herein can include other types of cable passages, such as apertures, slits, or slots, and other coupling blocks with other types of cable passages are described below.

The cable 80 is embodied as a type of ribbon or flat format optic cable 80. The cable 80 includes the outer jacket 82 and the optical fibers 84A-84N, which are arranged in a ribbon or flat format within the jacket 82, among possibly other components. The optical fibers 84A-84N can be formed from glass, plastic, and other suitable materials exhibiting internal refraction, such as Silica, Polymethylmethacrylate (PMMA), Polystyrene (PS), Polycarbonate (PC), and other suitable materials. The optical fibers 84A-84N can be formed at a typical or standard diameter, such as 80µm or 125 µm in diameter, although fibers of other sizes are within the scope of the embodiments. When the cable assembly 30 is assembled, the optical fibers 84A-84N are positioned into respective cable channels among the cable channels 44, as described below.

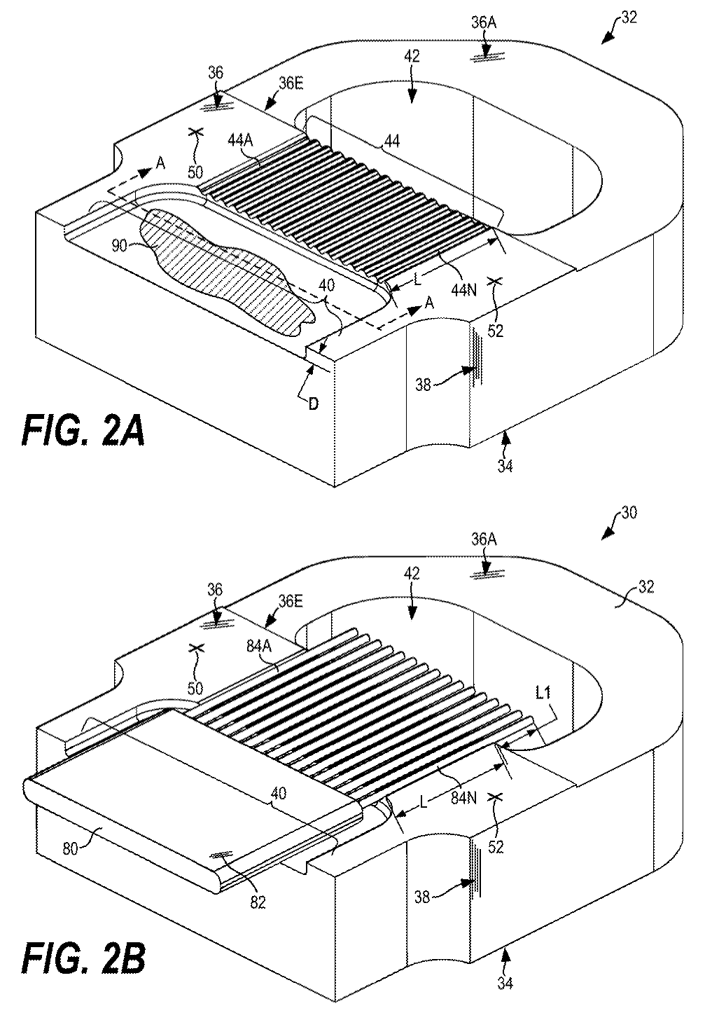

FIG. 2A illustrates a bottom perspective view of the coupling block 32, and FIG. 2B illustrates a bottom perspective view of the cable assembly 30. The fiber optic cable 80 is omitted from view in FIG. 2A but present in FIG. 2B. Thus, FIG. 2A illustrates only the coupling block 32, and FIG. 2B illustrates the cable assembly 30, which includes the coupling block 32 and the fiber optic cable 80 assembled together. FIG. 2A more clearly depicts the recess region 40 and the cable channels 44 of the coupling block 32. The recess region 40 is a depression formed from the lower block surface 36 and into the coupling block 32. The recess region 40 provides an area in which the cable 80 can be positioned and secured. The recess region 40 can be formed to a depth “D,” measured from the lower block surface 36 of the coupling block 32.

The cable channels 44 extend from an edge of the recess region 40 to the positioning edge 36E of the board recess surface 36A. In profile or shape, the cable channels 44 are formed in a wave shape in the example shown, and each cable channel among the cable channels 44 is shaped as a dipped or depressed channel, having a length “L.” Each cable channel among the cable channels 44 is depressed into the coupling block 32 from the lower block surface 36 of the coupling block 32. The cable channels 44 are depressed to a depth that is less than the depth “D” of the recess region 40 in the example shown in FIGS. 2A and 2B. The dimensions “L” and “D” can vary among the embodiments as described below.

The cable channels 44 include cable channels 44A-44N and correspond in number to the number of optical fibers 84A-84N in the cable 80. Sixteen (16) cable channels 44A-44N and sixteen (16) optical fibers 84A-84N are depicted in the example illustrated in FIGS. 2A and 2B. The coupling block 32 can include other numbers of cable channels, however, and the cable 80 can include other numbers of optical fibers in other cases. The cable assembly 30 can be adapted (e.g., changed in size, shape, etc.) to accommodate other numbers of cable channels and optical fibers, such as one, two, four, eight, thirty-two, or other numbers. Each of the cable channels 44A-44N is designed to support a respective one of the optical fibers 84A-84N. When the cable assembly 30 is assembled, the optical fibers 84A-84N are positioned in the cable channels 44A-44N, as shown in FIGS. 2A and 2B, and the cable channels 44A-44N help to maintain an even spacing and separation among the optical fibers 84A-84N.

The cable 80 can be secured to the coupling block 32 in a number of suitable ways. As one example, an adhesive 90 is shown applied or placed in the recess region 40 in FIG. 2A. The adhesive 90 can be an epoxy, a polyurethane, a polyimide, or other type of adhesive. The adhesive 90 can be a hot melt, reactive hold melt, thermosetting, or related classification of adhesive. The adhesive 90 can secure the cable 80, and particularly the outer jacket 82 of the cable 80, within the recess region 40. The adhesive 90 is illustrated as a representative example in FIG. 2A, and the amount, location, and other aspects of any adhesive used to assemble the cable assembly 30 can vary among the embodiments. In other examples, the cable 80 can be secured to the coupling block 32 using mechanical fasteners, mechanical interferences, and other mechanical approaches, as well as using a combination of mechanical and adhesive means.

When the cable assembly 30 is assembled as shown in FIG. 2B, the cable 80 is secured in position with the coupling block 32. Stated differently, the coupling block 32 is secured in position with respect to the cable 80, at one distal end of the cable 80. The optical fibers 84A-84N are positioned in and extend along the cable channels 44A-44N in this assembled configuration. The optical fibers 84A-84N extend beyond the cut end of the outer jacket 82 of the cable 80, along the full length “L” of the cable channels 44A-44N, and for an additional length “L1” across or over the window aperture 42 of the coupling block 32. The distance or additional length “L1” of the optical fibers 84A-84N over the window aperture 42 can be a design parameter and adjusted as compared to that shown.

The length “L1” of the optical fibers 84A-84N can be determined and controlled by cutting or trimming the optical fibers 84A-84N to the length shown. For that and other purposes, the coupling block 32 can include one or more fiducials or fiducial markers, such as the fiducials 50 and 52 shown in FIGS. 2A and 2B. The fiducials 50 and 52 can be printed, imprinted, stamped, embossed, molded, etched, scored or scratched, or otherwise formed on the lower block surface 36 of the coupling block 32. The fiducials 50 and 52 can vary in format, size, shape, and position as compared to that shown, and the coupling block 32 can include fewer or more than two fiducials in other cases. The fiducials 50 and 52 provide a type of datum or reference point against which other features, facets, edges, surfaces, or aspects of the cable assembly 30 can be tailored, selected, designed-for, measured, or otherwise established. The fiducials 50 and 52 can be omitted from the coupling block 32 in some cases. In other cases, the coupling block 32 can include fiducials on the upper block surface 34 or other surfaces.

The fiducials 50 and 52 can be identified by pick-and-place tools, as one example, with cameras or related machine-vision instruments. The pick-and-place tools can assemble the cable 80 with the coupling block 32 using the fiducials 50 and 52 as datum points. The fiducials 50 and 52 can also be relied upon for machining or otherwise forming certain features of the coupling block 32. As examples, the fiducials 50 and 52 can be relied upon as reference points for forming (e.g., machining, etching, etc.) the positioning edge 36E along one side of the board recess surface 36A. The fiducials 50 and 52 can also be relied upon as reference points for positioning the recess region 40, the cable channels 44, or other features of the coupling block 32. In other examples, the fiducials 50 and 52 can be relied upon by automated tools for cutting or trimming the optical fibers 84A-84N to a predetermined length, such as the length “L1” shown in FIG. 2B, as described in further detail below.

When the cable assembly 30 is interfaced with the substrate 20, the board recess surface 36A of the coupling block 32 can be placed against the top surface 22 of the substrate 20. The board recess surface 36A can be secured to the top surface 22 using soldering, sintering, brazing, or other approaches. In other cases, the board recess surface 36A can be secured to the top surface 22 using adhesives. The coupling block 32 can also be secured and aligned with the substrate 20 using mechanical fastening means, such as using one or more pins, rods, balls, clips, mechanical interferences or detents, and other means. The coupling block 32 can also be removed or removable from the substrate 20. The coupling block 32 can be removed by heating and reflowing the solder, sinter, braze or related bond between the coupling block 32 and the substrate 20, by removing the mechanical fastening means between them, or through other methods as needed. Thus, the coupling block 32 can be placed on, removed from, and re-placed on the substrate 20, either at the same or at different locations, any number of times as needed based on the application or use case.

FIG. 3 illustrates the sectional view of the coupling block 32 designated A-A in FIG. 2A. FIG. 3 depicts a side view of the recess region 40 and the cable channels 44 of the coupling block 32. The recess region 40 is formed to the depth “D,” as measured from the lower block surface 36 of the coupling block 32. The cable channels 44 are formed in a wave shape in the example shown, and each cable channel among the cable channels 44 is depressed into the coupling block 32 from the lower block surface 36 of the coupling block 32. The cable channels 44 are depressed or recess down to a depth “D1” below the lower block surface 36. “D1” is less than the depth “D” of the recess region 40 in the example shown. The dimensions “D” and “D1” can vary among the embodiments.

The view shown in FIG. 3 depicts how the wave surface of the cable channels 44 intersects with the board recess surface 36A (see FIGS. 2A and 2B), which is flat and planar. Stated differently, the surface of the cable channels 44 intersects, and intersects multiple times, with a plane in which the board recess surface 36A extends. The surface of the cable channels 44 resembles a wave in the example shown. In other cases, the cable channels 44 can be formed to have other waved, curved, semi-circular, “V,” “U,” or other surface profile shapes. The depth “D1,” inter-channel spacing, and other characteristics of the cable channels 44 can also vary as compared to that shown.

An outline of the optical fiber 84A is shown positioned within the cable channel 44A. As shown, the circular end of the optical fiber 84A intersects with the board recess surface 36A. Notably, when the coupling block 32 is assembled on the substrate 20, as shown in FIGS. 1A and 1B, the top surface 22 of the substrate 20 contacts and rests upon the board recess surface 36A of the coupling block 32. Thus, the cable assembly 30 is designed such that the positions of the optical fibers 84A-84N are predetermined with respect to the top surface 22 of the substrate 20, before the cable assembly 30 is assembled with the substrate 20. Stated differently, the extent of mechanical interference, or lack of interference, between the top surface 22 of the substrate 20 and the optical fibers 84A-84N can be controlled based on the design of the coupling block 32. For example, if the cable channels 44 are depressed or recess further (e.g., “D1” is greater than that shown) into the coupling block 32, then the optical fibers 84A-84N may interfere to a greater extent with the top surface 22 of the substrate 20. On the other hand, if the cable channels 44 are shallower (e.g., “D1” is less than that shown), then the optical fibers 84A-84N may interfere to a lesser extent with the top surface 22 of the substrate 20. The position of the board recess surface 36A, with respect to the lower block surface 36, can also be changed as compared to that shown.

The optical fibers 84A-84N can be processed by Thermally Expanded Core (TEC) techniques in some cases. TEC processing techniques can include applying heat to a length of one or more of the optical fibers 84A-84N, typically toward a distal end or tip of the optical fibers 84A-84N. The heat for TEC processing can be applied using a laser, as one example, and other TEC processing tools can also be relied upon. The heat applied during TEC processing can diffuse elements in the core of the optical fibers 84A-84N, such as Germanium, further into the cladding of the optical fibers 84A-84N. The TEC processing can expand the mode field diameter of the optical fibers 84A-84N, such as from 8-10µm to 20-35µm diameter, for example, to increase coupling efficiency. The expanded mode field diameter leads to relaxed alignment tolerances and increased mode matching with respect to the corresponding coupling structures, such as waveguides, laser diodes, or other structures on the substrate 20. TEC processing techniques can be applied to the optical fibers 84A-84N at a number of different stages in the assembly of the cable assembly 30, as described below.

The cable assembly 30 shown in FIGS. 1A, 1B, and 2B can be manufactured and assembled in a number of different ways. An example method of assembling the cable assembly 30 can include providing the coupling block 32, providing the cable 80, preparing the cable 80, positioning the cable 80 with the coupling block 32, and securing the cable 80 to the coupling block 32. The method can also include cutting or trimming the optical fibers 84A-84N of the cable 80 and preparing the optical fibers 84A-84N. The steps of assembling the cable assembly 30 can be performed in any suitable order, including an order different than that described below, in some cases.

The coupling block 32 can be separately formed or manufactured as described herein, sourced from a vendor, or be obtained in other ways. The cable 80 can be sourced from a vendor, for example, or separately manufactured. Preparing the cable 80 can include cutting back the jacket 82 of the cable 80 to expose a length of the optical fibers 84A-84N, processing the distal ends or tips of the optical fibers 84A-84N using TEC processing techniques, and possibly other steps as needed.

Positioning the cable 80 with the coupling block 32 can be performed manually, using automated pick-and-place tools, or other suitable approaches. The cable 80 can be positioned with the coupling block 32 such that the jacket 82 of the cable 80 is seated within the recess region 40 of the coupling block 32. The cable 80 can also be positioned with the coupling block 32 such that each optical fiber 84A-84N of the cable 80 is positioned in a respective one of the cable channels 44A-44N, as shown in FIG. 2B. The positioning step can be performed with reference to the fiducials 50 and 52, for example, as described above.

Securing the cable 80 to the coupling block 32 can be performed using adhesives, mechanical interferences or interlocks, a combination thereof, or other suitable means. Adhesives can be applied to the jacket 82 of the cable 80, to one or more surfaces of the coupling block 32, or both. The adhesives can be applied before, after, or both before and after the cable 80 is positioned with the coupling block 32. Curing (e.g., using heat, ultraviolet (UV) light, etc.) steps can also be performed to secure the cable 80 with the coupling block 32 using the adhesives, as needed.

The optical fibers 84A-84N can overhang (e.g., extend beyond) the positioning edge 36E and extend into the window aperture 42 after the cable 80 is secured to the coupling block 32. At this stage, the method can also include cutting or trimming the optical fibers 84A-84N of the cable 80. The optical fibers 84A-84N can be cut to a certain length of extension beyond the positioning edge 36E. As one example, the optical fibers 84A-84N can be cut or trimmed to the length L1 shown in FIG. 2B, and the optical fibers 84A-84N can be trimmed to other lengths as needed. The optical fibers 84A-84N can be cut or trimmed to the length L1 using manual or automated mechanical cutting or shearing tools, lasers, or other cutting tools. The cutting can be performed with reference to the fiducials 50 and 52, for example, using automated process techniques for accuracy. The length of the optical fibers 84A-84N beyond the positioning edge 36E can be selected and tailored as needed. The length can be selected to achieve a certain extent of flexibility or flexing of the fibers for alignment into channels on the substrate 20. Tailoring the length of the optical fibers 84A-84N can help to reduce the precision needed for and cost of the coupling block 32, whereas the channels on the substate 20 can be precisely formed in a more cost-effective way through semiconductor manufacturing processes. After cutting, the method can also include processing the distal ends or tips of the optical fibers 84A-84N using TEC processing techniques, if desired.

Once the cable assembly 30 is assembled and prepared for use, the cable assembly 30 can be positioned over and secured to the top surface 22 of the substrate 20, as shown in FIGS. 1A and 1B. When the cable assembly 30 is interfaced with the substrate 20, the board recess surface 36A of the coupling block 32 can be placed against the top surface 22 of the substrate 20. The positioning edge 36E of the coupling block 32 can also abut against and contact the edge 26 of the substrate 20 in that configuration. The board recess surface 36A can then be secured to the top surface 22 using soldering, sintering, or other approaches. In other cases, the board recess surface 36A can be secured to the top surface 22 using adhesives. The coupling block 32 can also be secured with the substrate 20 using mechanical fastening means, such as pins, rods, balls, mechanical interferences or detents, and other means.

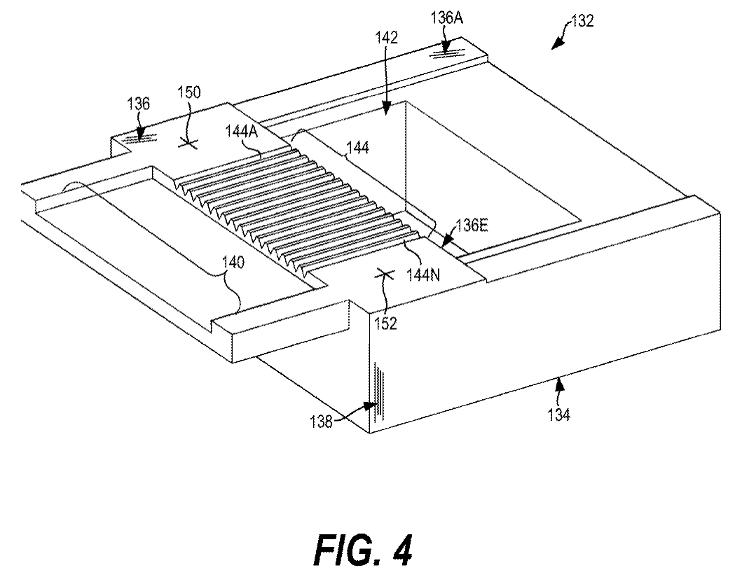

Turning to other examples, FIG. 4 illustrates another example coupling block 132 according to various embodiments of the present disclosure. The coupling block 132 shown in FIG. 4 is similar to the coupling block 32 shown in FIGS. 1A-1C, 2A, and 2B, although the coupling block 132 has some differences as compared to the coupling block 32. Although not shown in FIG. 4, a ribbon fiber optic cable, such as the cable 80, can be positioned with and secured to the coupling block 132, to form a cable assembly. The coupling block 132 can also be interfaced with a substate, such as the substrate 20.

The coupling block 132 can be formed from the same or similar materials as the coupling block 32. The coupling block 132 includes an upper block surface 134, a lower block surface 136, and a side surface 138. The coupling block 132 also includes a window aperture 142 that extends through the coupling block 132 from the upper block surface 134 to the lower block surface 136. The coupling block 132 also includes a board recess surface 136A that is formed into the lower block surface 134 of the coupling block 132. The lower block surface 136 extends in a plane that is separate from and parallel to the board recess surface 136A.

When the coupling block 132 is interfaced with a substrate, such as the substrate 20, the board recess surface 136A of the coupling block 132 can rest upon the top surface 22 of the substrate 20. A positioning edge 136E extends along one side of the board recess surface 136A. Along the length of the positioning edge 136E, a portion of the positioning edge 136E is shared and coincides with an inner surface of the window aperture 142. When the coupling block 132 is interfaced with the substrate 20, the positioning edge 136E can abut against and contact the edge 26 of the substrate 20.

One or more outer surfaces of the coupling block 132 can be selectively metalized or plated with a conductive plating metal or metals in some cases, and the coupling block 132 can be embodied as a plated plastic component. In one example, all exterior-facing outer surfaces of the coupling block 132 can be plated with a metal or metals. In other cases, only certain surfaces or surface regions of the coupling block 132 are plated, such as only the board recess surface 136A. The plating can provide an interface for bonding (e.g., soldering, sintering, etc.) the coupling block 132 to the substrate 20, a type of EMI shield, and other purposes.

The coupling block 132 also includes a cable termination bay. The cable termination bay is formed as a recess region 140. The recess region 140 is an area or region of the coupling block 132 that is recessed from the lower block surface 136. The recess region 140 has a type of boxed shape, as shown in FIG. 4. The recess region 140 provides an area in which the cable 80, for example, can be positioned and secured.

In the coupling block 132, a number of cable passages extend from the recess region 140 to the positioning edge 136E. In the embodiment shown in FIG. 4, the cable passages are formed as cable channels 144. The cable channels 144 are formed to have “V” profile shapes in the example shown, and cable channels having other profile shapes are described below. The depth, spacing, and other characteristics of the cable channels 144 can vary based on design considerations. The cable channels 144 include cable channels 144A-144N and correspond in number to the number of optical fibers 84A-84N in the cable 80. Each of the cable channels 144A-144N is designed to support a respective one of the optical fibers 84A-84N. When assembled with the cable 80, the optical fibers 84A-84N are positioned in the cable channels 144A-144N, and the cable channels 144A-144N help to maintain an even spacing and separation among the optical fibers 84A-84N.

The cable 80 or other cables can be secured to the coupling block 132 in a number of suitable ways. As one example, an adhesive can be applied or placed in the recess region 140. The adhesive can be an epoxy, a polyurethane, a polyimide, or other type of adhesive. The adhesive can be a hot melt, reactive hold melt, thermosetting, or related classification of adhesive. The adhesive can secure the cable 80, and particularly the outer jacket 82 of the cable 80, within the recess region 140. In other examples, the cable 80 can be secured to the coupling block 132 using mechanical fasteners, mechanical interferences, and other mechanical approaches, as well as using a combination of mechanical and adhesive means.

When the cable 80 is secured in position with the coupling block 132, the optical fibers 84A-84N can extend along the cable channels 144A-144N. The optical fibers 84A-84N can also extend beyond the positioning edge 136E for an additional length across or over the window aperture 142 of the coupling block 132. The distance of extension of the optical fibers 84A-84N over the window aperture 142 can be a design parameter that is tailored depending on the application.

The coupling block 132 can also include one or more fiducials or fiducial markers, such as the fiducials 150 and 152 shown in FIG. 4. The fiducials 150 and 152 can be printed, imprinted, stamped, embossed, molded, etched, scored or scratched, or otherwise formed on the lower block surface 136 of the coupling block 132. The fiducials 150 and 152 can vary in format, size, shape, and position as compared to that shown, and the coupling block 132 can include fewer or more than two fiducials in other cases. The fiducials 150 and 152 provide a type of datum or reference point against which other features, facets, edges, surfaces, or aspects of the coupling block 132 can be tailored, selected, designed-for, measured, or otherwise established. The fiducials 150 and 152 can be omitted from the coupling block 132 in some cases. In other cases, the coupling block 132 can include fiducials on the upper block surface 134 or other surfaces.

The fiducials 150 and 152 can be identified by pick-and-place tools, as one example, with cameras or related machine-vision instruments. The pick-and-place tools can assemble the cable 80 with the coupling block 132 using the fiducials 150 and 152 as datum points. The fiducials 150 and 152 can also be relied upon for machining or otherwise forming certain features of the coupling block 132. As examples, the fiducials 150 and 152 can be relied upon as reference points for forming (e.g., machining, etching, etc.) the positioning edge 136E. The fiducials 150 and 152 can also be relied upon as reference points for positioning the recess region 140, the cable channels 144, or other features of the coupling block 132. In other examples, the fiducials 150 and 152 can be relied upon by automated tools for cutting or trimming the optical fibers 84A-84N to a predetermined length within the window aperture 142.

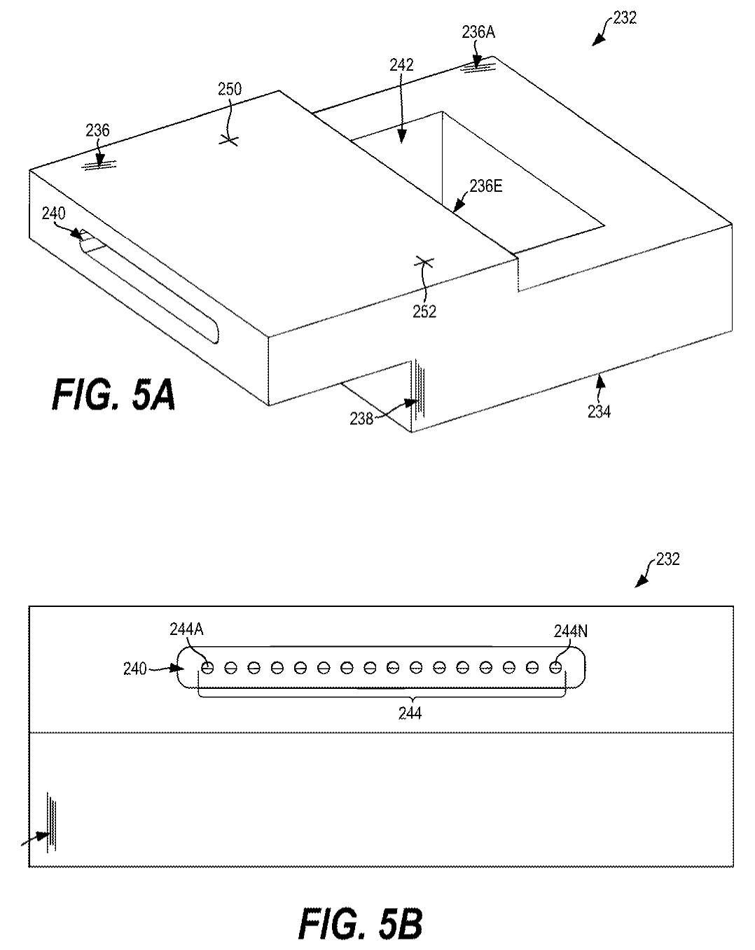

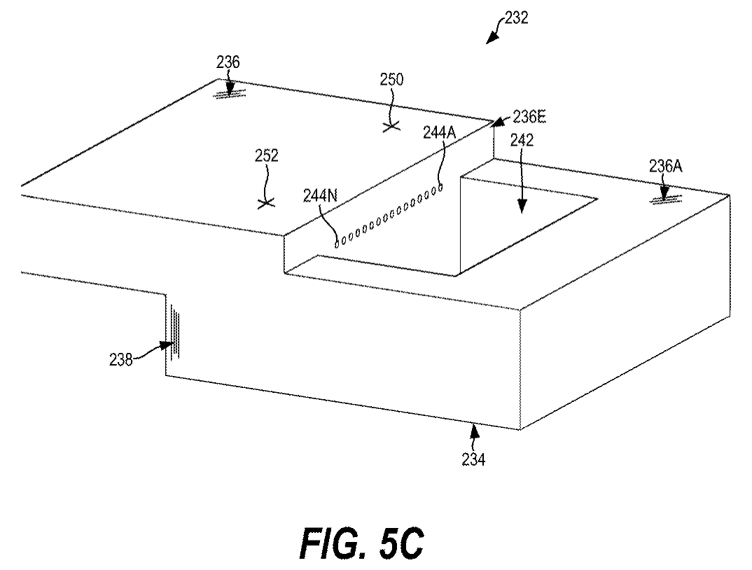

Turning to another example, FIG. 5A illustrates a first perspective view of another coupling block 232 according to various embodiments of the present disclosure. FIG. 5B illustrates a side view of the coupling block 232, and FIG. 5C illustrates a second perspective view of the coupling block 232. The coupling block 232 shown in FIGS. 5A-5C is similar to the coupling block 32 shown in FIGS. 1A-1C, 2A, and 2B and the coupling block 132 shown in FIG. 4, although the coupling block 232 has some differences as compared to the coupling blocks 32 and 132. A ribbon fiber optic cable, such as the cable 80, can be positioned with and secured to the coupling block 232, to form a cable assembly. The coupling block 232 can also be interfaced with a substate, such as the substrate 20.

The coupling block 232 can be formed from the same or similar materials as the coupling block 32. The coupling block 232 includes an upper block surface 234, a lower block surface 236, and a side surface 238. The coupling block 232 also includes a window aperture 242 that extends through the coupling block 232 from the upper block surface 234 to the lower block surface 236. The coupling block 232 also includes a board recess surface 236A that is depressed or separated from the lower block surface 234 of the coupling block 232. The lower block surface 236 extends in a plane that is separate from and parallel to the board recess surface 236A.

When the coupling block 232 is interfaced with a substrate, such as the substrate 20, the board recess surface 236A of the coupling block 232 can rest upon the top surface 22 of the substrate 20. A positioning edge 236E extends along one side of the board recess surface 236A. Along the length of the positioning edge 236E, a portion of the positioning edge 236E is shared and coincides with an inner surface of the window aperture 242. When the coupling block 232 is interfaced with the substrate 20, the positioning edge 236E can abut against and contact the edge 26 of the substrate 20.

One or more outer surfaces of the coupling block 232 can be selectively metalized or plated with a conductive plating metal or metals in some cases, and the coupling block 232 can be embodied as a plated plastic component. In one example, all exterior-facing outer surfaces of the coupling block 232 can be plated with a metal or metals. In other cases, only certain surfaces or surface regions of the coupling block 232 are plated, such as only the board recess surface 236A. The plating can provide an interface for bonding (e.g., soldering, sintering, etc.) the coupling block 232 to the substrate 20, a type of EMI shield, and other purposes.

The coupling block 232 also includes a cable termination bay. The cable termination bay is formed as a slot 240 in the example shown in FIGS. 5A and 5B. The slot 240 provides an area in which the cable 80, for example, can be positioned and secured. In the coupling block 232, a number of cable passages extend from within the slot 240 to the positioning edge 236E. In the embodiment shown in FIGS. 5A-5C, the cable passages are formed as cable apertures 244. The cable apertures 244 include cable apertures 244A-244N and correspond in number to the number of optical fibers 84A-84N in the cable 80. Each of the cable apertures 244A-244N is designed to receive a respective one of the optical fibers 84A-84N. When assembled with the cable 80, the optical fibers 84A-84N are inserted into and extended through the cable apertures 244A-244N. The cable apertures 244A-244N maintain an even spacing and separation among the optical fibers 84A-84N.

The cable 80 or other cables can be inserted into the slot 240 and secured within the slot 240. As one example, the cable 80 can be secured within the slot 240 using an adhesive. The adhesive can be an epoxy, a polyurethane, a polyimide, or other type of adhesive. The adhesive can be a hot melt, reactive hold melt, thermosetting, or related classification of adhesive. The adhesive can secure the cable 80, and particularly the outer jacket 82 of the cable 80, within the slot 240. In other examples, the cable 80 can be secured within the slot 240 using mechanical fasteners, mechanical interferences, and other mechanical approaches, as well as using a combination of mechanical and adhesive means.

When the cable 80 is secured in position with the coupling block 232, the optical fibers 84A-84N can extend through the cable apertures 244A-244N. The optical fibers 84A-84N can also extend beyond the positioning edge 236E for an additional length across or over the window aperture 242 of the coupling block 232. The distance of extension of the optical fibers 84A-84N over the window aperture 242 can be a design parameter that is tailored depending on the application.

The coupling block 232 can also include one or more fiducials or fiducial markers, such as the fiducials 250 and 252 shown in FIG. 5A. The fiducials 250 and 252 can be printed, imprinted, stamped, embossed, molded, etched, scored or scratched, or otherwise formed on the lower block surface 236 of the coupling block 232. The fiducials 250 and 252 can vary in format, size, shape, and position as compared to that shown, and the coupling block 232 can include fewer or more than two fiducials in other cases. The fiducials 250 and 252 provide a type of datum or reference point against which other features, facets, edges, surfaces, depressions or aspects of the coupling block 232 can be tailored, selected, designed-for, measured, or otherwise established. The fiducials 250 and 252 can be omitted from the coupling block 232 in some cases. In other cases, the coupling block 232 can include fiducials on the upper block surface 234 or other surfaces.

The fiducials 250 and 252 can be identified by pick-and-place tools, as one example, with cameras or related machine-vision instruments. The pick-and-place tools can assemble the cable 80 with the coupling block 232 using the fiducials 250 and 252 as datum points. The fiducials 250 and 252 can also be relied upon for machining or otherwise forming certain features of the coupling block 232. As examples, the fiducials 250 and 252 can be relied upon as reference points for forming (e.g., machining, etching, etc.) the positioning edge 236E. In other examples, the fiducials 250 and 252 can be relied upon by automated tools for cutting or trimming the optical fibers 84A-84N to a predetermined length within the window aperture 242.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account at least for some manufacturing tolerances between a theoretical design and a manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. An optical cable assembly, comprising:
a ribbon fiber optic cable; and
a coupling block positioned at one end of the ribbon fiber optic cable, the coupling block comprising:
an upper block surface and a lower block surface;
a window aperture that extends through the coupling block from the upper block surface to the lower block surface;
a board recess formed in the lower block surface; and
a plurality of cable passages formed in the lower block surface, the plurality of cable passages extending to a positioning edge of the coupling block along one side of the board recess.

2. The optical cable assembly according to claim 1, wherein the coupling block further comprises a cable termination bay adjacent to the lower block surface.

3. The optical cable assembly according to claim 2, wherein:
the cable termination bay comprises a recess region; and
a jacket of the ribbon fiber optic cable is secured to the coupling block in the recess region.

4. The optical cable assembly according to claim 2, wherein:
the cable termination bay comprises a recess slot; and
a jacket of the ribbon fiber optic cable is secured to the coupling block in the recess slot.

5. The optical cable assembly according to claim 1, wherein each optical fiber of the ribbon fiber optic cable is positioned in a respective cable passage among the plurality of cable passages.

6. The optical cable assembly according to claim 1, wherein each optical fiber of the ribbon fiber optic cable is positioned in a respective cable passage among the plurality of cable passages and extends a length past the positioning edge and into the window aperture.

7. The optical cable assembly according to claim 1, wherein the plurality of cable passages comprise a plurality of cable channels formed in a wave shape.

8. The optical cable assembly according to claim 1, wherein the plurality of cable passages comprise a plurality of cable channels formed in a “V” shape.

9. The optical cable assembly according to claim 1, wherein the plurality of cable passages comprise a plurality of apertures through the coupling block.

10. The optical cable assembly according to claim 1, wherein a surface of the plurality of cable passages intersects with a plane in which a board recess surface of the board recess extends.

11. A coupling block for an optical cable, comprising:
an upper block surface and a lower block surface;
a window aperture that extends through the coupling block from the upper block surface to the lower block surface;
a board recess formed in the lower block surface, the board recess comprising a positioning edge extending along one side of the board recess; and
a plurality of cable passages.

12. The coupling block according to claim 11, wherein:
the plurality of cable passages are formed in the lower block surface; and
the plurality of cable passages extend to a positioning edge of the coupling block along one side of the board recess.

13. The coupling block according to claim 11, wherein the coupling block further comprises a cable termination bay adjacent to the lower block surface.

14. The coupling block according to claim 13, wherein the cable termination bay comprises a recess region.

15. The coupling block according to claim 13, wherein the cable termination bay comprises a recess slot.

16. The coupling block according to claim 11, wherein a surface of the plurality of cable passages intersects with a plane in which the board recess surface extends.

17. The coupling block according to claim 11, wherein the plurality of cable passages comprise a plurality of apertures through the coupling block.

18. An optical interconnect assembly, comprising:
a substrate; and
an optical cable assembly secured along an edge of the substrate, the optical cable assembly comprising:
a ribbon fiber optic cable; and
a coupling block positioned at one end of the ribbon fiber optic cable.

19. The optical interconnect assembly according to claim 18, wherein the coupling block comprises:
an upper block surface and a lower block surface;
a window aperture that extends through the coupling block from the upper block surface to the lower block surface;
a board recess formed in the lower block surface, the board recess comprising a positioning edge extending along one side of the board recess; and
a plurality of cable passages.

20. The optical interconnect assembly according to claim 19, wherein a plurality of optical fibers of the ribbon fiber optical cable are positioned in and separated by the plurality of cable passages of the coupling block.
